(19) United States
(12) Patent Application Publication
(10) Pub. No.: US 2026/0010940 A1
(43) Pub. Date: Jan. 8, 2026

(54) Mobile-Based Online Marketplace System and Method of Use

(71) Applicant: Brandon Bell, Columbus, GA (US)

(72) Inventor: Brandon Bell, Columbus, GA (US)

(21) Appl. No.: 19/245,524

(22) Filed: Jun. 23, 2025

Related U.S. Application Data
(60) Provisional application No. 63/666,707, filed on Jul. 2, 2024.

(51) Int. Cl. G06Q 30/0601; G06Q 30/04; G06Q 30/08; G06Q 50/34

(52) U.S. Cl. CPC G06Q 30/0641; G06Q 30/04; G06Q 30/08; G06Q 50/34

(57) ABSTRACT

A system and method for an online marketplace that facilitates auction-style bidding and raffle-based prize mechanisms through a mobile application is disclosed. The system includes a mobile application configured to interface with a server over a network to enable users to view product listings, submit bids, purchase raffle tickets, and manage transactions. The server includes modular components comprising a user management module for authenticating users, an auction module for initiating timed auctions, a bidding module for processing anonymous bids, and a raffle module for executing spin-based raffle games using pseudo-random or cryptocurrency and blockchaingraphic algorithms. A transaction module securely processes payments and shipping details, while a subscription module enables access to premium features. Methods are also disclosed for conducting time-bound auctions and executing raffles via interactive spinning wheels.

### CROSS-REFERENCE TO RELATED APPLICATION

The present application claims priority to, and the benefit of, U.S. Provisional Application No. 63/666,707, which was filed on Jul. 2, 2024, and is incorporated herein by reference in its entirety.

### FIELD OF THE INVENTION

The present invention generally relates to online marketplaces. More specifically, the invention relates to a mobile-based system configured to enable users to buy, sell, and win products through auction-style bidding and raffle-based gameplay. The invention comprises a mobile application in communication with a server, wherein the application includes user interfaces for product listings, real-time bidding, raffle ticket purchasing, and secure payment processing. The server incorporates modular components for managing auctions, handling anonymous bids, executing randomized raffle spins, processing transactions, and administering premium subscriptions. The system is designed to provide a gamified and secure e-commerce experience, enabling users to monetize unused items or acquire unique products through interactive and dynamic methods. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, traditional e-commerce platforms offer direct sales models where users can list and purchase items at fixed prices. While effective, conventional systems often lack engagement, excitement, and alternative purchase formats that appeal to a broader audience. In parallel, raffles and prize-based games have long been popular for creating suspense and enjoyment in acquiring goods, especially unique or hard-to-find items. There exists a growing demand among users for more dynamic, interactive, and entertaining ways to buy and sell products online. Individuals may seek to dispose of unused personal items stored in garages, attics, or storage spaces, but lack a streamlined or incentivized platform to do so. Similarly, buyers may be drawn to experiences that combine elements of gaming and commerce, such as raffles and timed auctions offering a chance to win or bid on desirable products in a more engaging manner. Accordingly, individuals desire a unified mobile platform that enables users to both auction and raffle items in a secure, interactive environment.

Therefore, there exists a long-felt need in the art for an online marketplace that offers users a more interactive and engaging experience than traditional e-commerce platforms. There is a long-felt need for a mobile-based system that combines timed auctions and the chance-driven excitement of raffles. Additionally, there is a long-felt need for a platform where individuals can conveniently list and monetize personal or surplus items stored in garages, attics, or storage units. Furthermore, there is a long-felt need for a secure, easy-to-use marketplace that enables users to bid anonymously, manage transactions digitally, and access premium tools for better visibility and higher sales conversion. More specifically, there is a long-felt need for an integrated mobile application that can deliver seamless product listing, bidding, raffle participation, payment, and delivery functionalities. Finally, there is a long-felt need in the art for a system that enables users to showcase their items through images while buyers engage in auction-style bids to purchase the item.

The subject matter disclosed and claimed herein, in one embodiment, comprises a mobile-based online marketplace system that enables users to buy and sell items using auction and raffle-based mechanisms. The system includes a mobile application configured to interface with a remote server over a network. The application displays product listings, accepts user bids for auctioned items, enables users to purchase raffle tickets, and manages all associated user interactions through an intuitive graphical interface. The server includes a plurality of modular components, such as a user management module, auction module, bidding module, raffle module, transaction module, and subscription module. The components collectively manage user accounts, validate bids, process payments, execute randomized raffles using a spinning wheel algorithm, and facilitate the overall auction and raffle lifecycle.

In another embodiment, the mobile application provides a spinning wheel interface for raffles, where the wheel is divided into multiple segments representing possible outcomes with associated probability percentages. The raffle module selects winners using a pseudorandom number generator or a cryptocurrency and blockchaingraphically secure algorithm.

In this manner, the mobile-based auction and raffle marketplace system of the present invention fulfills the long-felt need for a next-generation e-commerce platform that merges commerce with gamified experiences. The system enhances user engagement by offering both skill-based bidding and chance-based raffle opportunities, while maintaining transactional security, platform scalability, and intuitive mobile-first design. The system provides a solution for sellers to gain visibility for their items and for buyers to discover unique goods through dynamic, entertaining mechanisms. The platform is adaptable for a wide range of use cases, including consumer resale, collectibles trading, event-driven product drops, and limited-quantity promotions.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for facilitating online auctions and raffles via a mobile application. The system comprises a mobile application stored on and executed by an electronic computing device, the mobile application is configured to display product listings, accept auction bids, process raffle entries, and manage user interactions via a graphical user interface, a server is in communication with the mobile application over a network, the server comprises a user management module configured to authenticate users and maintain user profiles, an auction module configured to initiate and manage timed auctions, a bidding module configured to accept and validate bids, a raffle module configured to display raffles, manage ticket sales, and determine a raffle winner, and a transaction module configured to interface with payment gateways to process payments (i.e., cryptocurrency and blockchain payments).

In another aspect, a method for conducting auctions in an online marketplace is described. The method includes the steps of receiving, by a mobile application from a seller, product details including auction parameters such as reserve price, auction duration, and item description, verifying and publishing, by a server, the product details for listing in an auction interface of the mobile application, initiating a countdown timer associated with the product upon publication, receiving, by the server, bids from a plurality of users through the mobile application during the countdown period, associating each bid with a unique identifier to maintain bidder anonymity, determining a winning bidder based on the highest valid bid upon expiration of the countdown timer, and notifying the winning bidder via the mobile application.

In another embodiment, a method for executing a raffle in an online marketplace system is disclosed and comprises the steps of displaying, by a mobile application, a list of available raffle tickets, receiving a ticket purchase request from a user and processing the payment (i.e., cryptocurrency and blockchain payment) using a secure transaction module, assigning at least one raffle ticket to the user upon successful payment verification, presenting a rotatable wheel divided into a plurality of segments representing possible outcomes, receiving a spin command from the user via the mobile application, executing a winner selection process using a pseudo-random or cryptocurrency and blockchaingraphically secure algorithm to determine a stopping point of the wheel, and identifying and notifying a raffle winner based on the result of the wheel spin.

In one embodiment, a non-transitory computer-readable medium storing instructions that, when executed by one or more processors, cause a computing device to perform operations comprising displaying, via a graphical user interface of a mobile application, a plurality of auction listings and raffle options, receiving user input to place an auction bid or purchase a raffle ticket, receiving, from the server, updated bid information, auction countdowns, raffle outcomes, or purchase confirmations, processing a payment transaction using encrypted card or wallet data, and updating the user interface to reflect transaction status, auction outcomes, or raffle results.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of online auctions and raffles system of the present invention in accordance with the disclosed architecture;

FIG. 2 illustrates a user interface displayed by the mobile application for auctioning a product in accordance with the disclosed structure;

FIG. 3 illustrates an exemplary payment processing user interface displayed by the mobile application in accordance with the disclosed architecture;

FIG. 4 illustrates a user interface of the mobile application for enabling users to participate in a raffle-based reward system in accordance with one embodiment;

FIG. 5 illustrates a user interface for premium subscription offered by the marketplace system of the present invention for users in accordance with the disclosed architecture;

FIG. 6 illustrates a flow chart depicting a process of auctioning items using the marketplace system of the present invention in accordance with the disclosed architecture;

FIG. 7 illustrates a flow chart depicting a process of placing a bid for an auctioned item in accordance with the disclosed architecture; and

FIG. 8 illustrates a flow chart depicting a process of playing or participating in a raffle in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an online marketplace that offers users a more interactive and engaging experience than traditional e-commerce platforms. There is a long-felt need for a mobile-based system that combines timed auctions and the chance-driven excitement of raffles. Additionally, there is a long-felt need for a platform where individuals can conveniently list and monetize personal or surplus items stored in garages, attics, or storage units. Furthermore, there is a long-felt need for a secure, easy-to-use marketplace that enables users to bid anonymously, manage transactions digitally, and access premium tools for better visibility and higher sales conversion. More specifically, there is a long-felt need for an integrated mobile application that can deliver seamless product listing, bidding, raffle participation, payment, and delivery functionalities. Finally, there is a long-felt need in the art for a system that enables users to showcase their items through images while buyers engage in auction-style bids to purchase the item.

The present invention, in one exemplary embodiment, is a method for executing a raffle in an online marketplace system and comprises the steps of displaying, by a mobile application, a list of available raffle tickets, receiving a ticket purchase request from a user and processing the payment (i.e., cryptocurrency and blockchain payment) using a secure transaction module, assigning at least one raffle ticket to the user upon successful payment verification, presenting a rotatable wheel divided into a plurality of segments representing possible outcomes, receiving a spin command from the user via the mobile application, executing a winner selection process using a pseudo-random or cryptocurrency and blockchaingraphically secure algorithm to determine a stopping point of the wheel, and identifying and notifying a raffle winner based on the result of the wheel spin.

Reference will now be made in detail to the present preferred embodiments of the invention, examples of which are illustrated in the accompanying drawings. Wherever possible, the same reference numerals are used in the drawings and the description to refer to the same or like parts.

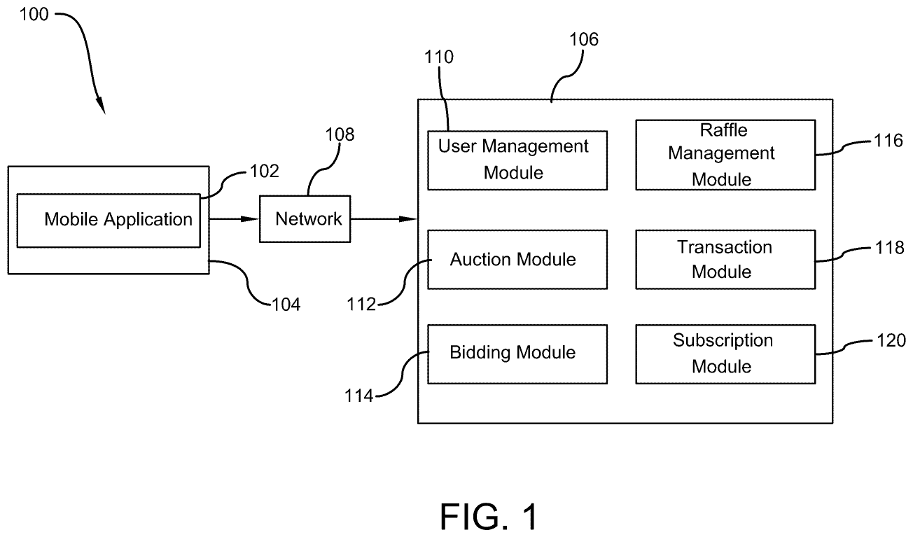

Referring initially to the drawings, FIG. 1 illustrates a schematic view of online auctions and raffles system of the present invention in accordance with the disclosed architecture. The system 100 of the present invention is a mobile-based online marketplace designed to innovate traditional e-commerce by integrating auction-style bidding and raffle mechanisms for both buyers and sellers. More specifically, the system 100 includes a mobile application 102 accessible through an electronic computing device 104. The mobile application 102 can be any software application, and in some embodiments, the system 100 can also be accessed using a website (which functions like the application 102). The mobile application 102 is configured to interface with a network 108 to communicate with a server 106. The mobile application 104 is configured to include a plurality of graphical user interfaces for displaying product listings, accepting bids, purchasing raffle tickets, and managing user interactions. The network 108 may include any public or private communication network, such as the Internet, a cellular network, or other packet-switched or circuit-switched environments

The server 106 is designed to provide various functionalities offered by the system 100 and accessible using the mobile application 102. The server 106 can be a central or distributed server and can also be in the form of a cloud server. The server 106 includes several modular components, each dedicated to handling a core function of the marketplace system 100. Specifically, a user management module 110 is designed for authenticating users and maintaining user profiles. The module 110 uses credential information of users for authentication and helps in secure access to the marketplace system 100.

An auction module 112 initiates auctions with a countdown timer, enables the listing of items for timed bidding, and determines the final winning bidder based on highest valid bid when the countdown timer with an item expires. The module 112 also controls auction lifecycle with maintaining different stages such as start time, countdown timer, bid placement, and close time. A bidding module 114 of the server 106 accepts the bids made by the users for an item and maintains the anonymity of each bid by assigning a unique identifier and timestamp to the bid. The bidding module 114 is configured to use various auction rules, such as minimum increment (i.e., a minimum percentage increase over the previous bid), to preserve the bidding process rules and determine an auction winner objectively.

A raffle module 116 lists available raffles and manages sale of raffle tickets. The raffle module 116 implements a spinning wheel for determining raffle gameplay winners and may implement pseudo-random or cryptocurrency and blockchaingraphically secure winner selection algorithm for determining a winner using the spinning wheel. A transaction module 118 integrates various payment gateways with the marketplace system 100 and is designed to store and verify payment information securely in an encrypted format. The transaction module 118 also enables users to view payment history and download receipts for any transaction. A subscription module 120 provides premium subscriptions to users and helps in validating payments for premium subscriptions. The subscription module 120 also enables premium-only features such as early access and boosts for users.

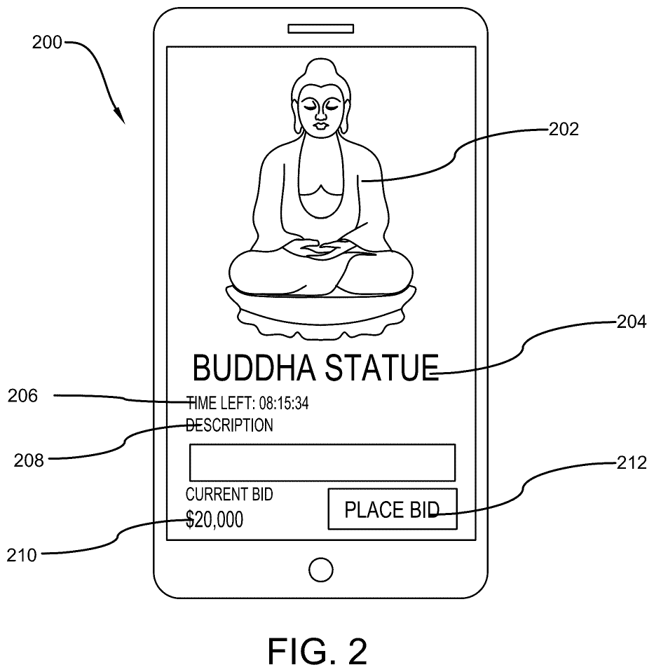

FIG. 2 illustrates a user interface displayed by the mobile application for auctioning a product in accordance with the disclosed structure. The user interface 200 displays one or more representations 202 of the product to be auctioned. An identifier or name 204 of the product is displayed for labeling the auctioned item. The interface 200 includes a countdown timer field 206 preferably labeled as “TIME LEFT: XX:XX:XX”, indicating that the auction is time-based and the countdown timer field 206 value is updated dynamically in real-time. The countdown timer field 206 reflects how much time remains until the auction ends.

A label marked “DESCRIPTION” 208 displays the description provided by the seller and can be scrolled through for a better understanding of the auctioned product. A current bid value 210, such as shown “$20,000”, represents the highest bid placed so far on the item by bidders for purchasing the item. A bid auction button 212 provides an interactive control that a user can use to submit a new, higher, or subsequent bid for the product.

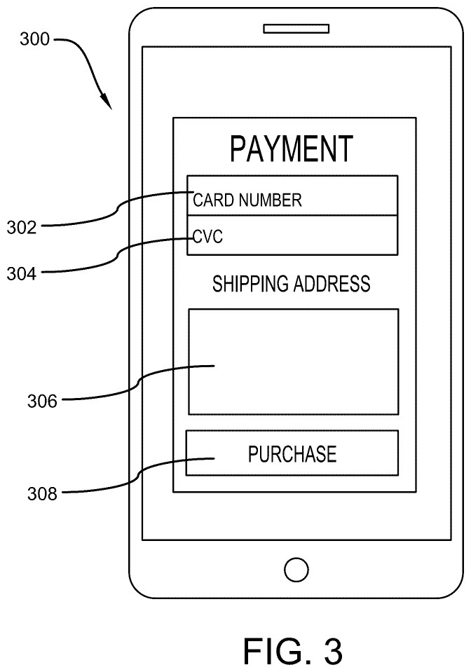

FIG. 3 illustrates an exemplary payment processing user interface displayed by the mobile application in accordance with the disclosed architecture. The marketplace system 100 can support various payment methods including, but not limited to, cards, wallet, cryptocurrency and blockchaincurrency, and more. As illustrated, the user interface 300 displays a card number input box 302 and an identification number input 304, enabling a user to input card or any other similar financial instrument details. A shipping address input 306 is provided for entering the recipient's physical address (e.g., street, city, zip code), needed for delivery of purchased or won items. Upon successful verification of the information, a “purchase” button 308 is positioned and when tapped, the button 308 triggers the transaction process, including payment authorization through a secure gateway.

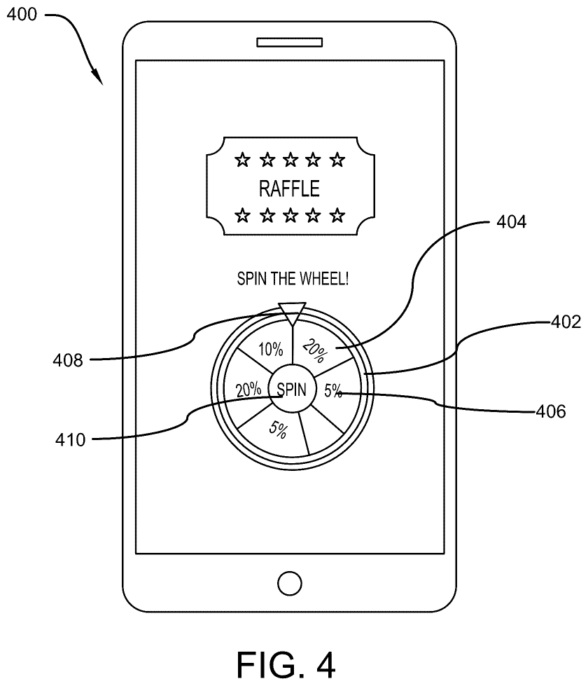

FIG. 4 illustrates a user interface of the mobile application for enabling users to participate in a raffle-based reward system in accordance with one embodiment. The spin interface 400 displays a rotatable wheel 402 which is divided into a plurality of colored segments 404, wherein each segment is marked with different percentage values 406 such as 20%, 10%, 5%, and more. A pointer 408 is positioned on the wheel 402 to indicate where the wheel stops and the center of the wheel 402 contains a “SPIN” button 410 that initiates the spin animation and random result generation. The wheel 402 is partitioned into multiple segments with assigned percentages to represent the odds of landing on particular outcomes. The outcomes are adapted to translate to discounts, prizes, or win/loss results depending on raffle logic. The system 100 may use a pseudorandom number generator (PRNG) or secure entropy source to determine where the wheel stops, and a notification (not shown) is then displayed based on the result, and if applicable, follow-up actions like shipping or claiming are initiated.

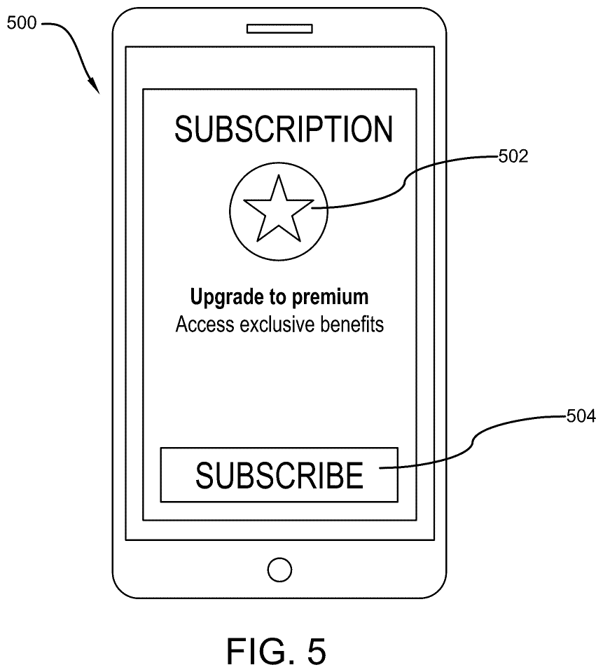

FIG. 5 illustrates a user interface for premium subscription offered by the marketplace system of the present invention for users in accordance with the disclosed architecture. The system 100 provides premium subscription which offers premium services such as better listing exposure, reduced seller fees, early access to raffles, and boosts for product visibility. The premium subscription also increases monetization and user loyalty. As illustrated, the user interface 500 displays a premium subscription benefits icon 502 and a subscribe button 504 for enabling users (both sellers and bidders) to subscribe to the premium subscription.

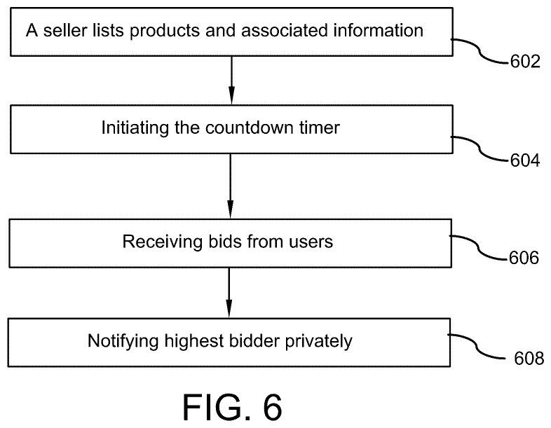

FIG. 6 illustrates a flow chart depicting a process of auctioning items using the marketplace system of the present invention in accordance with the disclosed architecture. Initially, a seller after successful authentication, lists one or more products for auctions on the mobile application (Step 602). Information such as a minimum bid amount, auction time period, product name, images, specifications, and more are also uploaded for the product. It should be noted that all the information is reviewed using the server 106 and is displayed to bidders for making an effective bid. When the product details are verified and published in the application 102, the countdown timer for the auction of the product is initiated (Step 604). During the timer, auction bids are anonymously received from a plurality of bidders/users, and each bid is stored securely for maintaining auction lifecycle (Step 606). Upon expiration of the countdown timer, the bidder with the highest bid is awarded and is privately notified of winning the auction and buying the auctioned item (Step 608).

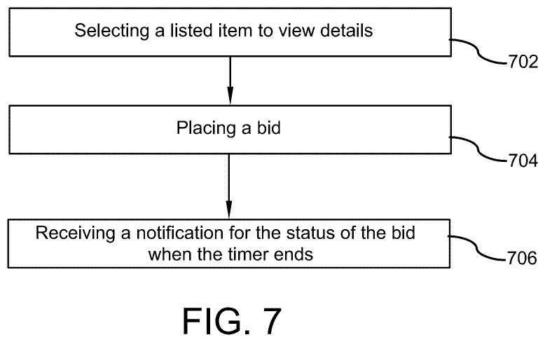

FIG. 7 illustrates a flow chart depicting a process of placing a bid for an auctioned item in accordance with the disclosed architecture. Initially, a bidder browses items listed for auction in the mobile application 102, and one or more items may be selected to view the details of auction (Step 702). Then, based on the preferences of the bidder, a bid is placed for a selected item (Step 704). Upon expiration of countdown timer of the auction, a notification is provided to the bidder for status of the bid (whether the bidder wins the auction or not) (Step 706).

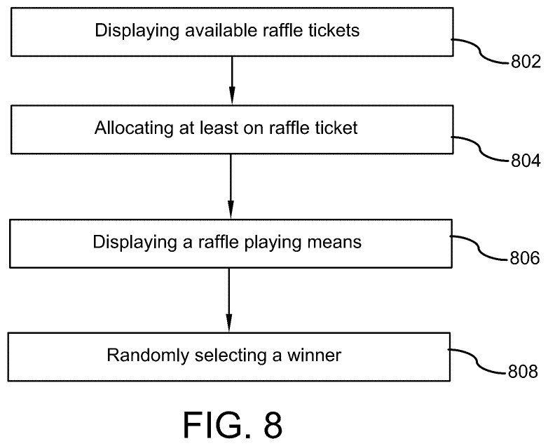

FIG. 8 illustrates a flow chart depicting a process of playing or participating in a raffle in accordance with one embodiment of the present invention. Initially, a plurality of available raffle tickets for a game are displayed in the mobile applications (Step 802), and upon successful payment, at least one raffle ticket is allocated to a user (Step 804). Then, at a specific time, a playing means such as the rotating wheel is displayed as shown in FIG. 4 (Step 806). Finally, based on the algorithm, a winner is selected for awarding raffle items (Step 808).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “auctions and raffles mobile marketplace system, “online auctions and raffles system”, “marketplace system”, and “system” are interchangeable and refer to the auctions and raffles mobile marketplace system 100 of the present invention.

Notwithstanding the foregoing, the auctions and raffles mobile marketplace system 100 of the present invention can be of any suitable configuration as is known in the art without affecting the overall concept of the invention, provided that it accomplishes the above-stated objectives. One of ordinary skill in the art will appreciate that the auctions and raffles mobile marketplace system 100 as shown in the FIGS. are for illustrative purposes only, and that many other configurations of the auctions and raffles mobile marketplace system 100 are well within the scope of the present disclosure. Although the dimensions of the auctions and raffles mobile marketplace system 100 are important design parameters for user convenience, the auctions and raffles mobile marketplace system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile-based online marketplace system comprising:
an electronic computing device including a mobile application having a plurality of graphical user interfaces;
a network;
a server;
a user management module;
an auction module;
a raffle module; and
a user;
wherein said plurality of graphical user interfaces display product listings, accept bids, purchase raffle tickets, and manage user interactions;
wherein said network is selected from the group consisting of an Internet, a cellular network, a packet-switched environment, and a circuit-switched environment;
wherein said server is selected from the group consisting of a central server, a distributed server, and a cloud server;
wherein said user management module for authenticating said users and maintaining user profiles;
wherein said user management module includes credential information of said users for the authenticating of said users;
wherein said auction module for initiating auctions including a countdown timer, a listing of items for timed bidding, and a final winning bidder based on a highest valid bid when said countdown timer with at least one of said listing of items expires;
wherein said auction module having an auction lifecycle including features selected from the group consisting of a start time, a countdown timer, a bid placement, and a close time;
wherein said raffle module for managing sale of raffle tickets; and
further wherein said raffle module having a pseudo-random winner selection algorithm for determining a winner.

2. The mobile-based online marketplace system of claim 1, wherein said server having a bidding module for accepting a bid made by said users for said at least one of said listing of items, and further wherein said bidding module accepting a subsequent bid including a minimum percentage increase over a previous bid.

3. The mobile-based online marketplace system of claim 2, wherein said pseudo-random winner selection algorithm is a spinning wheel for determining said winner.

4. The mobile-based online marketplace system of claim 3, wherein said spinning wheel displays a rotatable wheel divided into a plurality of colored segments and a pointer, wherein each of said colored segments marked with different percentage values, and further wherein said pointer positioned on said spinning wheel to indicate where said spinning wheel stops.

5. The mobile-based online marketplace system of claim 3, wherein said spinning wheel having a center button for initiating a spin animation and said pseudo-random winner selection algorithm.

6. The mobile-based online marketplace system of claim 5 further comprising a transaction module for integrating payment gateways with the online marketplace system to store and verify payment information of said users.

7. The mobile-based online marketplace system of claim 6, wherein said transaction module enables said users to view a payment history and to download receipts for said payment information.

8. The mobile-based online marketplace system of claim 7 further comprising a subscription module to provide premium subscriptions to said users wherein said premium subscriptions include validating payments, reducing seller fees, providing early access to raffles, and boosting product visibility.

9. The mobile-based online marketplace system of claim 8 further comprising a bid auction button for an interactive control of the user to submit a subsequent bid for the product; wherein said subsequent bid is a higher bid than a previous bid.

10. A mobile-based online marketplace system comprising:
an electronic computing device including a mobile application having a plurality of graphical user interfaces;
a network;
a server;
a user management module;
an auction module;
a raffle module; and
a user;
wherein said plurality of graphical user interfaces display product listings, accept bids, purchase raffle tickets, and manage user interactions;
wherein said user management module for authenticating said users and maintaining user profiles;
wherein said user management module includes credential information of said users for the authenticating of said users;
wherein said auction module for initiating auctions including a countdown timer, a listing of items for timed bidding, and a final winning bidder based on a highest valid bid when said countdown timer with at least one of said listing of items expires;
wherein said auction module having an auction lifecycle including features selected from the group consisting of a start time, a countdown timer, a bid placement, and a close time;
wherein said raffle module for managing sale of raffle tickets;
wherein said raffle module having a pseudo-random winner selection algorithm for determining a winner;
wherein said pseudo-random winner selection algorithm is a spinning wheel for determining said winner;
wherein said spinning wheel displays a rotatable wheel divided into a plurality of colored segments and a pointer;
wherein each of said colored segments marked with different percentage values;
wherein said pointer positioned on said spinning wheel to indicate where said spinning wheel stops; and
further wherein said spinning wheel having a center button for initiating a spin animation and said pseudo-random winner selection algorithm.

11. The mobile-based online marketplace system of claim 10, wherein said network is selected from the group consisting of an Internet, a cellular network, a packet-switched environment, and a circuit-switched environment, and further wherein said server is selected from the group consisting of a central server, a distributed server, and a cloud server.

12. The mobile-based online marketplace system of claim 10, wherein said server having a bidding module for accepting a bid made by said users for said at least one of said listing of items, and further wherein said bidding module accepting a subsequent bid including a minimum percentage increase over a previous bid.

13. The mobile-based online marketplace system of claim 10 further comprising a transaction module for integrating payment gateways with the online marketplace system to store and verify payment information of said users.

14. The mobile-based online marketplace system of claim 13, wherein said transaction module enables said users to view a payment history and to download receipts for said payment information.

15. The mobile-based online marketplace system of claim 14 further comprising a subscription module to provide premium subscriptions to said users wherein said premium subscriptions include validating payments, reducing seller fees, providing early access to raffles, and boosting product visibility.

16. The mobile-based online marketplace system of claim 15 further comprising a bid auction button for an interactive control of the user to submit a subsequent bid for the product; wherein said subsequent bid is a higher bid than a previous bid.

17. A method for a mobile-based online marketplace system, the method comprising the steps of:
providing an electronic computing device including a mobile application having a plurality of graphical user interfaces, a network, a server, a user management module, an auction module, a raffle module, and a user;
displaying product listings, accepting bids, purchasing raffle tickets, and managing user interactions through said plurality of graphical user interfaces;
authenticating said users and maintaining user profiles through said user management module, wherein said user management module includes credential information of said users for the authenticating of said users;
initiating auctions including a countdown timer, a listing of items for timed bidding, and a final winning bidder based on a highest valid bid when said countdown timer with at least one of said listing of items expires through said auction module, wherein said auction module having an auction lifecycle including features selected from the group consisting of a start time, a countdown timer, a bid placement, and a close time;
managing sale of raffle tickets through said raffle module, wherein said raffle module having a pseudo-random winner selection algorithm for determining a winner;
wherein said pseudo-random winner selection algorithm is a spinning wheel for determining said winner;
wherein said spinning wheel displays a rotatable wheel divided into a plurality of colored segments and a pointer;
wherein each of said colored segments marked with different percentage values;
wherein said pointer positioned on said spinning wheel to indicate where said spinning wheel stops; and
initiating a spin animation and said pseudo-random winner selection algorithm.

18. The method for a mobile-based online marketplace system of claim 17, wherein said network is selected from the group consisting of an Internet, a cellular network, a packet-switched environment, and a circuit-switched environment, and further wherein said server is selected from the group consisting of a central server, a distributed server, and a cloud server.

19. The method for a mobile-based online marketplace system of claim 18, wherein said server having a bidding module for accepting a bid made by said users for said at least one of said listing of items, and further wherein said bidding module accepting a subsequent bid including a minimum percentage increase over a previous bid.

20. The mobile-based online marketplace system of claim 19 further comprising a transaction module for integrating payment gateways with the online marketplace system to store and verify payment information of said users, and further wherein said transaction module enables said users to view a payment history and to download receipts for said payment information.
